(19) United States
(12) Patent Application Publication
(10) Pub. No.: US 2019/0118773 A1
(43) Pub. Date: Apr. 25, 2019

(54) USER AUTHENTICATION SYSTEM, USER AUTHENTICATION METHOD AND SERVER

(71) Applicants: Hyundai Motor Company, Seoul (KR); Kia Motors Corporation, Seoul (KR)

(72) Inventor: Sunghwan Choi, Yongin (KR)

(21) Appl. No.: 15/834,604

(22) Filed: Dec. 7, 2017

(30) Foreign Application Priority Data
Oct. 25, 2017 (KR) 10-2017-0139165

(51) Int. Cl. B60R 25/25; G06F 21/32; B60R 25/20; B60R 25/24

(52) U.S. Cl. CPC B60R 25/25; B60R 25/241; B60R 25/2018; G06F 21/32

(57) ABSTRACT

A user authentication system includes: a server storing identification information and bio-information of a user; and a vehicle comprising: a receiver receiving the identification information from the server; a sensor sensing bio-information; and a transmitter transmitting the sensed bio-information and the received identification information to the server. The server authenticates the user based on the identification information and the bio-information received from the transmitter.

### CROSS-REFERENCE TO RELATED APPLICATION

This application claims the benefit of priority to Korean Patent Application No. 10-2017-0139165, filed on Oct. 25, 2017 in the Korean Intellectual Property Office, the disclosure of which is incorporated herein by reference in its entirety as if fully set forth herein.

### BACKGROUND

### 1. Technical Field

Embodiments of the present disclosure relate generally to user authentication, and more particularly, to techniques for determining whether a user is authorized to use a vehicle on the basis of the user's identification information and bio-information.

### 2. Description of the Related Art

Modern vehicles are equipped with various electronic devices, such as hands-free devices, global positioning system (GPS) receivers, Bluetooth devices, hi-pass device devices, and the like, for the purpose of enhancing driver and passenger convenience. As vehicles are increasingly shared by multiple people, a user authentication process is necessary to prevent theft of the vehicle.

In many conventional user authentication technologies, a user is authenticated by comparing a password input to an authentication device (e.g., through a keypad) with a previously stored password. With the advancement of scientific techniques, user authentication technology has integrated biological characteristics, such as a genetic trait, fingerprint, voice, vein, appearance, iris, etc., in order to provide more exact authentication.

An example authentication method which has been widely used is authentication using a user's bio-information, e.g., the user's fingerprint. In this regard, the user authentication process is performed by transmitting a user's bio-information (sensed by a vehicle, for example) to a server and comparing the received bio-information with bio-information stored in the server.

However, in this process, a comparison must be performed between the bio-information received from the vehicle with each of the pieces of bio-information stored in the server. Thus, the user authentication result can be quickly transmitted when the amount of user information stored in the server is small, but it takes considerable time to perform the same process when the amount of user information stored in the server is large.

### SUMMARY

It is an aspect of the present disclosure to provide a user authentication system and user authentication technology capable of more quickly and effectively authenticating a user using the user's identification information and bio-information.

Additional aspects of the disclosure will be set forth in part in the description which follows and, in part, will be apparent from the description, or may be learned by practice of the disclosure.

In accordance with embodiments of the present disclosure, a user authentication system includes: a server storing identification information and bio-information of a user; and a vehicle comprising: a receiver receiving the identification information from the server; a sensor sensing bio-information; and a transmitter transmitting the sensed bio-information and the received identification information to the server. The server authenticates the user based on the identification information and the bio-information received from the transmitter.

When the identification information received from the transmitter is the same as the identification information stored in the server, the server may authenticate the user based on the bio-information received from the transmitter.

The server may authenticate the user based on whether the identification information received from the transmitter is the same as the identification information stored in the server.

The server may transmit a result of the authentication of the user to the receiver of the vehicle.

When the authentication of the user is completed successfully, information to the receiver of the vehicle including at least one of the authenticated user's integrated memory system (IMS) information, head up display (HUD) information, and body control module (BCM) information.

The vehicle may further include a controller controlling an operation of the vehicle based on the information received by the receiver.

The identification information may include an identification (ID) of the user.

The server may create identification information of the user based on the bio-information of the user.

When the authenticated user's operation of the vehicle has ended, the controller may delete the identification information and the bio-information of the user.

When the authenticated user's operation of the vehicle has ended, the server may delete the identification information of the user and create new identification information of the user.

The server may transmit the new identification information of the user to the receiver.

The sensor may include at least one sensor sensing fingerprint information of the user, the at least one sensor provided on at least one of a steering wheel, a door, a dashboard, a switch, a start button, a center console, and a center fascia of the vehicle.

Furthermore, in accordance with embodiments of the present disclosure, a user authentication method of a user authentication system including a vehicle and a server includes: receiving bio-information from a user; creating identification information of the user based on the bio-information; storing the created identification information and the bio-information in the server; transmitting the identification information to the vehicle; sensing bio-information of the user; transmitting the sensed bio-information and the identification information to the server; and authenticating the user based on the identification information and the bio-information received from the vehicle.

The authenticating of the user may include authenticating the user based on the bio-information received from the vehicle when the identification information received from the vehicle is the same as the identification information stored in the server.

The authenticating of the user may include authenticating the user based on whether the identification information received from the vehicle is the same as the identification information stored in the server.

The user authentication method may further include transmitting a result of the authentication of the user to the vehicle.

The creating of the identification information of the user may include creating identification information of the user based on the bio-information of the user.

The user authentication method may further include deleting the identification information and the bio-information of an authenticated user when an operation of the vehicle by the authenticated user has ended.

Furthermore, in accordance with embodiments of the present disclosure, a server includes: a server storage part storing first identification information and first bio-information of a user; a server communicator transmitting the first identification information of the user to a vehicle and receiving second identification information and second bio-information of the user from the vehicle; and a server controller authenticating the user based on the first bio-information and the second bio-information of the user when the first identification information is the same as the second identification information.

When the first identification information is the same as the second identification information, the server controller may determine that the user is authorized to control the vehicle, and authenticate the user.

The first bio-information may be created based on the first identification information.

The second bio-information may include bio-information of the user obtained from the vehicle.

The server communicator may transmit a result of the authentication of the user to the vehicle.

When an operation of the vehicle by an authenticated user has ended, the server controller may delete the first identification information and the second identification information and creates new first identification information of the user.

The server communicator may transmit the new first identification information of the user to the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating the exterior of a vehicle in accordance with embodiments of the present disclosure;

FIG. 2 is a diagram illustrating the inside of a vehicle in accordance with embodiments of the present disclosure;

FIG. 3 is a block diagram illustrating some components of a user authentication system in accordance with embodiments of the present disclosure;

FIG. 4 is a diagram illustrating a conventional method of comparing bio-information transmitted from a vehicle with bio-information stored in a server;

FIG. 5 is a diagram illustrating a method of comparing bio-information transmitted from a vehicle with bio-information stored in a server, in accordance with embodiments of the present disclosure;

FIG. 6 is a diagram illustrating a method of determining the identity of a fingerprint among a user's bio-information, in accordance with embodiments of the present disclosure;

FIG. 7 is a flowchart of a user authentication method in accordance with embodiments of the present disclosure;

FIG. 8 is a flowchart of a method of controlling a server, in accordance with embodiments of the present disclosure; and

FIGS. 9 to 11 are diagrams illustrating various locations of a sensor capable of obtaining a user's bio-information, in accordance with embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments set forth herein and structures illustrated in the drawings are examples of the present disclosure, and there may be various modified examples which may replace the embodiments and the drawings at the filing date of the present application.

The terms used herein are merely used to describe embodiments and are not intended to restrict and/or limit the scope of the present disclosure. As used herein, the singular forms are intended to include the plural forms as well, unless the context clearly indicates otherwise.

It will be understood that the terms “comprise” and/or “comprising,” when used in this specification, specify the presence of stated features, integers, steps, operations, elements, components, or groups thereof, but do not preclude the presence or addition of one or more other features, integers, steps, operations, elements, components, or groups thereof. It will be further understood that, although the terms “first,” “second,” “third,” etc., may be used herein to describe elements, these elements should not be limited by these terms. As used herein, the singular forms “a,” “an,” and “the” are intended to include the plural forms as well, unless the context clearly indicates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

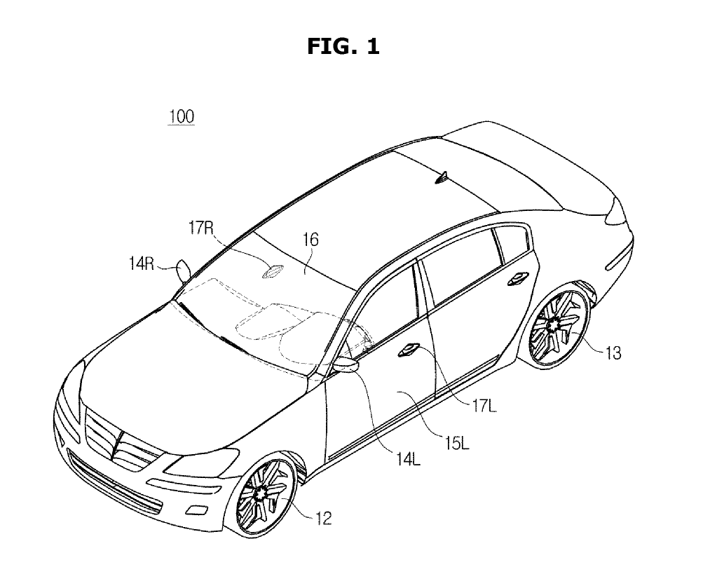

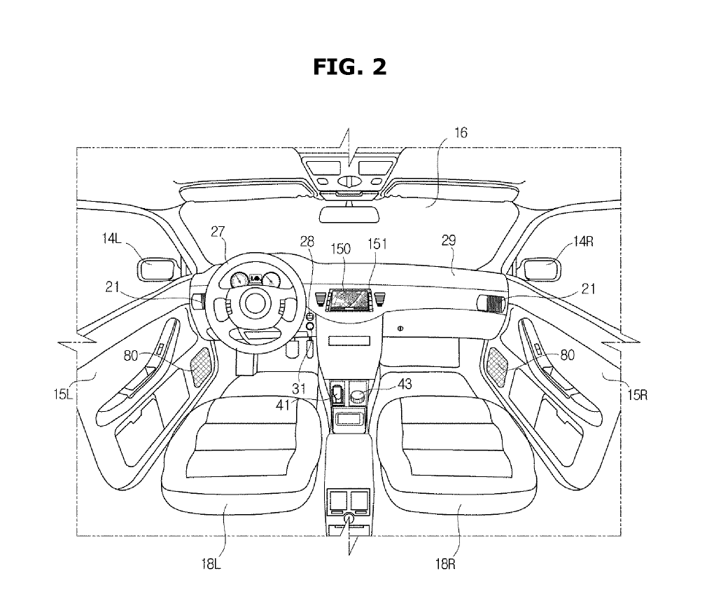

Hereinafter, embodiments of the present disclosure will be described in detail with reference to the accompanying drawings so that those of ordinary skill in the art may easily implement the embodiments. For clarity, parts which are not related to clearly describing the present disclosure are omitted in the drawings. Hereinafter, a vehicle to which the present disclosure is applicable will be described with reference to FIGS. 1 and 2.

FIG. 1 is a diagram illustrating the exterior of a vehicle in accordance with embodiments of the present disclosure. FIG. 2 is a diagram illustrating the inside of a vehicle in accordance with embodiments of the present disclosure. FIGS. 1 and 2 will be described together below to avoid redundancy.

As shown in FIG. 1, the exterior of a vehicle 100 in accordance with embodiments of the present disclosure may include wheels 12 and 13 configured to move the vehicle 100, doors 15R and 15L configured to shield the inside of the vehicle 100 from the outside, a front glass 16 configured to provide a user inside the vehicle 100 with a field of view in front of the vehicle 100, and side-view mirrors 14L and 14R configured to provide the user with a field of view in the rear direction of the vehicle 100.

The wheels 12 and 13 include the front wheels 12 at the front of the vehicle 100 and the rear wheels 13 at the back of the vehicle 100. A driving device (not shown) inside the vehicle 100 may provide rotational force to the front wheels 12 or the rear wheels 13 so as to move the vehicle 100 in a forward or backward direction. The driving device may employ either an engine which burns a fossil fuel to generate the rotational force or a motor which receives power from a capacitor and generates the rotational force.

The doors 15L and 15R are provided at left and right sides of the vehicle 100 to be rotationally moved, whereby a user or a passenger may enter the vehicle 100 when they are opened and the inside of the vehicle 100 may be shielded from the outside when they are closed. Handles 17L and 17R may be provided at an outer side of the vehicle 100, through which the doors 15L and 15R may be opened or closed. A Bluetooth antenna for transmitting or receiving a Bluetooth (low frequency) signal and a touch sensor (not shown) for sensing a user's touch input may be installed at the handle 17L.

When the touch sensor of the doors 15L and 15R senses a user's touch input in a state in which the user owns a remote manipulation device (not shown), the vehicle 100 may authenticate the remote manipulation device via a wireless communication network. When the authentication of the remote manipulation device is completed, a door lock of the vehicle 100 may be released and the doors 15L and 15R may be opened by the user pulling the handles 17L and 17R. Here, the user may be understood to include a passenger who enters the vehicle 100, as well the user.

The front glass 16 is provided at a front upper side of a body of the vehicle 100, whereby a user inside the vehicle 100 may obtain visual information in front of the vehicle 100, and may be also referred to as a windshield glass.

The side-view mirrors 14L and 14R include the left side-view mirror 14L at a left side of the vehicle 100 and the right side-view mirror 14R at a right side of the vehicle 100, whereby a user inside the vehicle 100 may obtain visual information at lateral and rear sides of the vehicle 100.

In addition, although not shown, the vehicle 100 may include sensor devices, such as a proximity sensor which senses an obstacle or other vehicles at a rear or lateral side of the vehicle 100, a rain sensor which senses precipitation and a precipitation rate, etc.

The proximity sensor may transmit a sensing signal to the rear or lateral side of the vehicle 100 and receive a signal reflected from an obstacle such as another vehicle. Whether an obstacle is present at the rear or lateral side of the vehicle 100 may be sensed and the location of the obstacle may be detected on the basis of a wavelength of the reflected signal. A method of transmitting an ultrasonic wave or an infrared ray and detecting a distance to an object using an ultrasonic wave or an infrared ray reflected from the obstacle may be employed as an example of the proximity sensor.

It should be understood that the exterior of the vehicle 100 as described above and illustrated in FIG. 1 is provided merely for demonstration purposes, and thus does not limit the scope of the present disclosure.

As shown in FIG. 2, a display 150 configured to display a video or an image provided from an audio/video navigation (AVN) terminal and an AVN input unit 151 may be provided in a central region of a dashboard 29. The display 150 may selectively display at least one among an audio screen, a video screen, and a navigation screen, and may display various control screens related to the vehicle 100 or a screen related to additional functions of the vehicle 100.

The display 150 may be implemented as a liquid crystal display (LCD), a light-emitting diode (LED), a plasma display panel (PDP), an organic light emitting diode (OLED), a cathode ray tube (CRT), or the like.

The AVN input unit 151 may be provided in the form of a hard key type in a region near the display 150. When the display 150 is implemented as a touch screen type, the AVN input unit 151 may be provided in a touch panel form on a front surface of the display 150.

A jog shuttle type center input unit 62 may be provided between a driver's seat 18L and a passenger's seat 18R. A user may input a control command by turning or pressing the center input unit 62 or pushing the center input unit 62 in an upward, downward, left or right direction.

An output unit configured to output sound may be provided in the vehicle 100. The output unit may include a speaker 80. The speaker 80 may output sound necessary to perform an audio function, a video function, a navigation function, and other additional functions.

Although FIG. 2 illustrates that speakers 80 are respectively provided for the driver's seat 18L and the passenger's seat 18R, embodiments are not limited thereto and the speaker 141 may be provided at various locations inside the vehicle 100.

A steering wheel 27 is provided on the dashboard 29 near the driver's seat 18L. A groove 28 for inserting a key may be formed in a region adjacent to the steering wheel 27, into which a remote manipulation device (not shown) such as a FOB key, may be inserted. When an external terminal is inserted into the groove 28 for inserting a key or authentication between the external terminal and the vehicle 100 is completed via a wireless communication network, the external terminal and the vehicle 100 may be connected to each other.

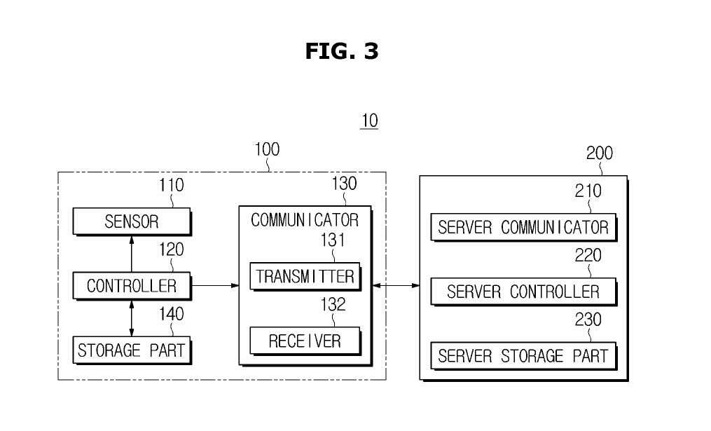

A start button 31 configured to turn on or off the vehicle 100 may be provided on the dashboard 29. When an external terminal 200 of FIG. 3 is inserted into the groove 28 for inserting a key or authentication between an external terminal (not shown) and the vehicle 100 is successfully performed via a wireless communication network, the vehicle 100 may be ‘on’ when a user pressurizes the start button 31.

An air conditioning device 21 may be provided in the vehicle 100 to perform heating or cooling, and may control the internal temperature of the vehicle 100 by discharging heated or cooled air via the air conditioning 21.

Outer and inner components of the vehicle 100 which is a component of the user authentication system 10 have been described above. Components of the user authentication system 10 in accordance with embodiments of the present disclosure will be described below.

It should be understood that the interior of the vehicle 100 as described above and illustrated in FIG. 2 is provided merely for demonstration purposes, and thus does not limit the scope of the present disclosure.

FIG. 3 is a block diagram illustrating some components of a user authentication system 10 in accordance with embodiments of the present disclosure.

As shown in FIG. 3, the user authentication system 10 in accordance with embodiments of the present disclosure may include a vehicle 100 and a server 200. The vehicle 100 may include a sensor 110 configured to sense and obtain a user's bio-information, a communicator 130 including a receiver 132 configured to receive the user's identification information from a server 200 and a transmitter 131 configured to transmit the user's identification information and bio-information to the server 200, a storage part 140 storing information regarding the user such as the user's identification information and bio-information, and a controller 120 configured to control various devices included in the vehicle 100 and control the vehicle 100 on the basis of a user authentication result received from the server 200. The server 200 may include a server storage part 230 storing the user's identification information and bio-information, and a server controller 220 configured to perform a user authentication process on the basis of the user's identification information and bio-information received from the communicator 130.

The sensor 110 may sense the user's bio-information, and obtain the user's bio-information when the user's bio-information is sensed.

In detail, when the user's bio-information is sensed by a sensor (not shown) installed on any of various locations in the vehicle 100, the sensor 110 may obtain the user's bio-information from the sensor and transmit the user's bio-information to the controller 120 or the communicator 130.

Although for convenience of explanation, the user's fingerprint will be described herein as an example of the user's bio-information, the user's bio-information is not limited to the user's fingerprint and any information regarding the user, e.g., a genetic trait, voice, vein, appearance, or iris, which indicates a biological feature of the user may be included in the user's bio-information.

The sensor 110 may include various devices configured to sense and obtain the user's bio-information. For example, the sensor 110 may include a fingerprint sensor for obtaining the user's fingerprint information or a face or eye sensor for obtaining the user's facial information. However, embodiments are not limited thereto and any device capable of obtaining the user's bio-information may be included as a component of the sensor 110.

Thus, the sensor may sense and obtain the user's bio-information using the fingerprint sensor provided at at least one of the steering wheel 27, the doors 15L and 15R, the dashboard 29, the start button 31, a center console, and a center fascia of the vehicle 100.

The communicator 130 may include the receiver 132 configured to receive the user's identification information from the server 200, and the transmitter 131 configured to transmit the bio-information obtained by the sensor 110 and the received user's identification information to the server 200.

In detail, the receiver 132 of the communicator 130 may receive the user's identification information stored in the server 200 by the user, e.g., the user's unique identification (ID), from the server 200.

When the user's bio-information is obtained by the sensor 110 after the user's ID is received by the receiver 132, the transmitter 131 may transmit the obtained user's bio-information and the received user's identification information to the server 200.

Thus, the communicator 130 may establish communication with the server 200 according to various methods. The communicator 130 may transmit information to or receive information from the server 200 according to various methods, e.g., radio frequency (RF), wireless fidelity (Wi-Fi), Bluetooth, Zigbee, near-field communication (NFC), or ultra-wide band (UWB) communication. A method of establishing communication with the server 200 is not limited thereto and any method of establishing communication with the server 200 is usable.

Although for convenience of explanation, FIG. 3 illustrates that the transmitter 131 and the receiver 132 are separately provided, embodiments of the present disclosure are not limited thereto and the transmitter 131 and the receiver 132 may be implemented as one component and communicate with the server 200.

The storage part 140 may store various types of information such as the user's identification information and bio-information.

In detail, the storage part 140 may store the user's identification information, e.g., information regarding the user's ID, received from the server 200, or the user's bio-information sensed by the sensor 110. However, as will be described below, when the vehicle 100 is shared by multiple people, such information may be deleted by the controller 120 according to a predetermined condition to prevent the theft of the vehicle 100.

The storage part 140 may be implemented as, but is not limited to, at least one among a nonvolatile memory device such as a cache, a read-only memory (ROM), a programmable ROM (PROM), an erasable programmable ROM (EPROM), an electrically erasable programmable ROM (EEPROM) or a flash memory, a volatile memory device such as a random access memory (RAM), and a storage medium such as a hard disk drive (HDD) or a CD-ROM. The storage part 140 may be a memory implemented as a chip separately from a processor which will be described below in relation to the controller 120, or may be implemented as a chip included in the processor.

The controller 120 may control various components of the vehicle 100. Furthermore, when a user authentication result is received from server 200, the controller 120 may control the vehicle 100 on the basis of the user authentication result.

In detail, when the receiver 132 receives a result indicating that authentication of the user has been completed normally from the server 200, the controller 120 determines that the user is authorized to control the vehicle 100 and allows the user to open the doors 15L and 15R of the vehicle 100 or is authorized to control the vehicle 100 without starting the vehicle 100. Furthermore, the controller 120 may display information indicating the completion of the authentication of the user on the display 150.

However, when the receiver 132 receives a result indicating that authentication of the user has failed from the server 200, the controller 120 determines that the user is not authorized to control the vehicle 100 and does not allow the user to open the doors 15L and 15R of the vehicle 100 or is not authorized to control the vehicle 100 without starting the vehicle 100.

Furthermore, when the receiver 132 receives the result indicating that authentication of the user has been completed normally from the server 200, the controller 120 may control various components of the vehicle 100 on the basis of at least one among the user's integrated memory system (IMS) information, head up display (HUD) information and body control module (BCM) information included in the received result.

That is, when the authentication of the user is completed normally, it may be determined that the user is authorized to control the vehicle 100 and various components of the vehicle 100 may be automatically controlled on the basis of information set for the various components of the vehicle 100 by the user.

The controller 120 may be implemented as a memory (not shown) configured to store either an algorithm for controlling the components of the vehicle 100 or data regarding a program realizing the algorithm, and a processor (not shown) configured to execute the above-described operations using data stored in the memory. In this case, the memory and the processor may be implemented as different chips. Alternatively, the memory and the processor may be implemented as one chip together.

Although not shown, the vehicle 100 may include the display 150 capable of outputting a user authentication result received from the controller 120 or the receiver 132 to the outside.

In detail, when the receiver 132 receives a user authentication result from the server 200, the controller 120 may display the user authentication result on the display 150. If the receiver 132 receives a result indicating that user authentication has failed from the server 200, this result may be displayed on the display 150.

Thus, the display 150 may include a display panel (not shown) for displaying this information. As the display panel, a cathode ray tube (CRT) display panel, a liquid crystal display (LCD) panel, a light-emitting diode (LED) panel, an organic light emitting diode (OLED) panel, a plasma display panel (PDP), a field-emission display (FED) panel, or the like may be employed.

The server 200 may include a server communicator 210 configured to establish communication with the vehicle 100, the server storage part 230 configured to store bio-information received from a user and identification information regarding the user created on the basis of the bio-information, and the server controller 220 configured to perform a user authentication process by determining whether bio-information which is the same as the bio-information received from the communicator 130 is stored in the server storage part 230.

The server communicator 210 may transmit the user's identification information stored in the server storage part 230 and bio-information created on the basis of the identification information to the communicator 130 of the vehicle 100, and receive the user's identification information and bio-information, which are obtained from the user, from the vehicle 100.

The server storage part 230 may store various types of information regarding the user, e.g., the user's bio-information and the user's identification information created on the basis of the user's bio-information.

A user should store his or her identification information and bio-information in the server 200 beforehand to use a vehicle sharing system. Thus, the bio-information, e.g., fingerprint information, may be stored in the server storage part 230 by the user, and identification information, e.g., the user's ID, which is created on the basis of the bio-information may be stored together with the bio-information.

The server controller 220 may perform a user authentication process on the basis of the user's identification information and bio-information received from the transmitter 131.

In detail, whether identification information which is the same as the user's identification information received from the transmitter 131 is stored in the server storage part 230 may be determined, and then whether bio-information which is the same as the user's bio-information received from the transmitter 131 is stored in the server storage part 210 may be determined when identification information which is the same as the received user's identification information is stored in the server storage part 230.

That is, first, whether there is identification information which is the same as the received user's identification information may be determined, and when there is the same identification information, whether bio-information stored in the server storage part 230 to correspond to the same identification information is the same as the bio-information received from the transmitter 131 may be determined to perform user authentication.

If both the identification information and the bio-information are the same as the received user's identification information and bio-information, the user is authorized to control the vehicle 100 and thus user authentication is successfully performed. However, when the identification information is the same as the received user's identification information but the bio-information is not the same as the received user's bio-information, a user registered in the server storage part 210 and the user who actually wants to use the vehicle 100 are not the same. Thus, user authentication is not successfully performed.

Although for convenience of explanation, FIG. 3 illustrates that the server storage part 230 and the server controller 220 are separate components, embodiments are not limited thereto and the server storage part 230 and the server controller 220 may operate as one component.

At least one component may be added or deleted according to the performance of the components of the vehicle 100 illustrated in FIG. 3. Furthermore, it would be apparent to those of ordinary skill in the art that the locations of the components may vary according to the performance or structure of the system.

Each of the components illustrated in FIG. 3 may be software and/or a hardware component such as a field programmable gate array (FPGA) and an application specific integrated circuit (ASIC).

The components of the user authentication system 10 in accordance with embodiments of the present disclosure have been described above with reference to FIG. 3. A user authentication method in accordance with an embodiment will be described with reference to the accompanying drawings.

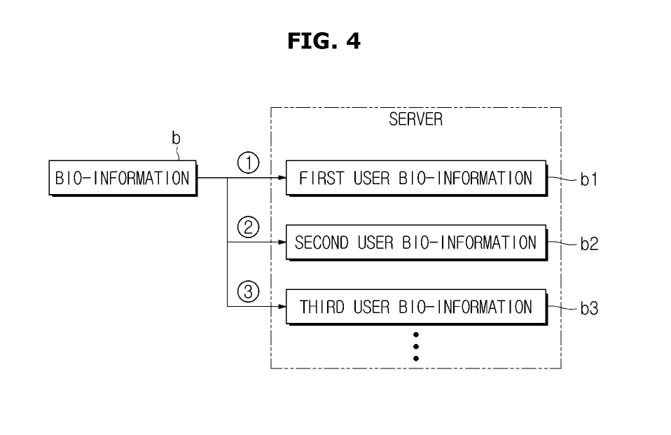

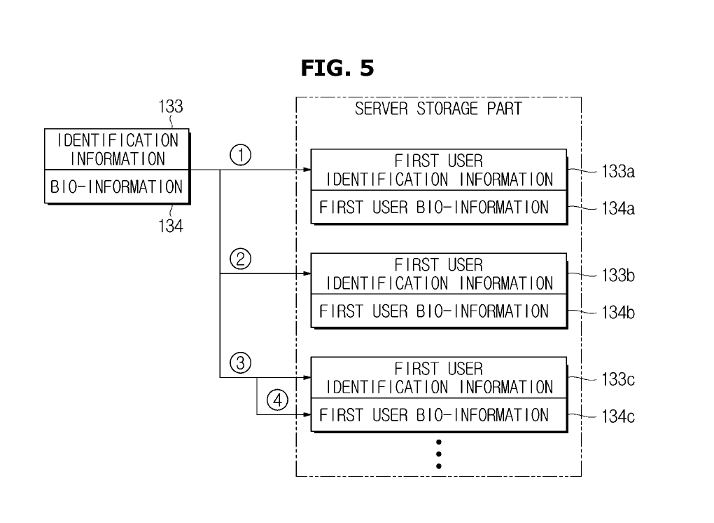

FIG. 4 is a diagram illustrating a conventional method of comparing bio-information transmitted from a vehicle with bio-information stored in a server. FIG. 5 is a diagram illustrating a method of comparing bio-information transmitted from a vehicle 100 with bio-information stored in a server 200, in accordance with embodiments of the present disclosure.

As shown in FIG. 4, in a conventional user authentication method using fingerprints, user authentication is performed by matching bio-information transmitted to a server with each of pieces of bio-information stored in the server.

In this case, when the amount of the bio-information stored in the server is not large, it does not take a long period of time to complete the user authentication. However, the matching of the bio-information needs more time than when another method is used to perform the user authentication. Thus, when the amount of bio-information stored in the server is large, it takes a long period of time to perform user authentication.

That is, when user authentication is performed as illustrated in FIG. 4, bio-information b transmitted from the vehicle is matched with each of first user bio-information b1, second user bio-information b2, and third user bio-information b3 stored in the server and thus a long period of time is consumed for the user authentication.

In contrast, as illustrated in FIG. 5, in a user authentication method in accordance with embodiments of the present disclosure, bio-information is not directly compared, first, identification information, e.g., IDs, may be primarily classified, and when there are the same IDs, whether bio-information stored to correspond to this ID and bio-information transmitted from the vehicle 100 are the same is determined. Thus, user authentication may be more quickly completed.

That is, as illustrated in FIG. 5, identification information 133 received from the vehicle 100 may be compared with first user identification information 133a, second user identification information 133b, and third user identification information 133c stored in the server storage part 220. Then, when the third user identification information 133c which is the same as the identification information 133 received from the vehicle 100 is stored in the server storage part 220, third user bio-information 134c stored in the server storage part 220 to correspond to the third user identification information 133c may be compared with bio-information 134 received from the vehicle 100 to determine whether the third user bio-information 134c and the bio-information 134 are the same.

It takes less time when pieces of the same bio-information are detected using identification information such as an ID than when pieces of the same bio-information are detected by matching pieces of bio-information. In conclusion, a process of determining whether pieces of bio-information are the same may be performed only once, thereby more quickly completing a user authentication process.

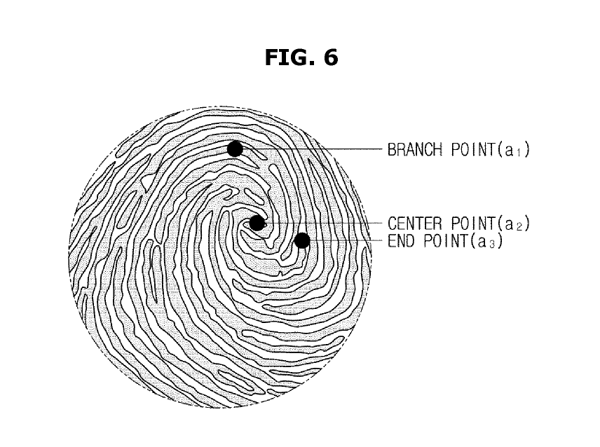

FIG. 6 is a diagram illustrating a method of determining the identity of a fingerprint among a user's bio-information, in accordance with embodiments of the present disclosure.

The method of determining the identity of a fingerprint among a user's bio-information is performed in multiple stages. Although not shown, when a fingerprint image is input, first, noise is removed from the fingerprint image and a direction of the fingerprint is extracted. Then, a binarization process is performed to simplify the fingerprint in black and white using shading information, and a thinning process is performed to change each black side of the fingerprint into a single line. Thereafter, as illustrated in FIG. 6, feature points of the fingerprint are extracted, and the identity of the fingerprint is determined on the basis of digital information obtained by digitalizing the feature points.

That is, a branch point a₁, a center point a₂, an end point a₃, etc. of the fingerprint illustrated in FIG. 6 may be extracted and the identity of the fingerprint is determined on the basis of the branch point a₁, the center point a₂, the end point a₃, etc.

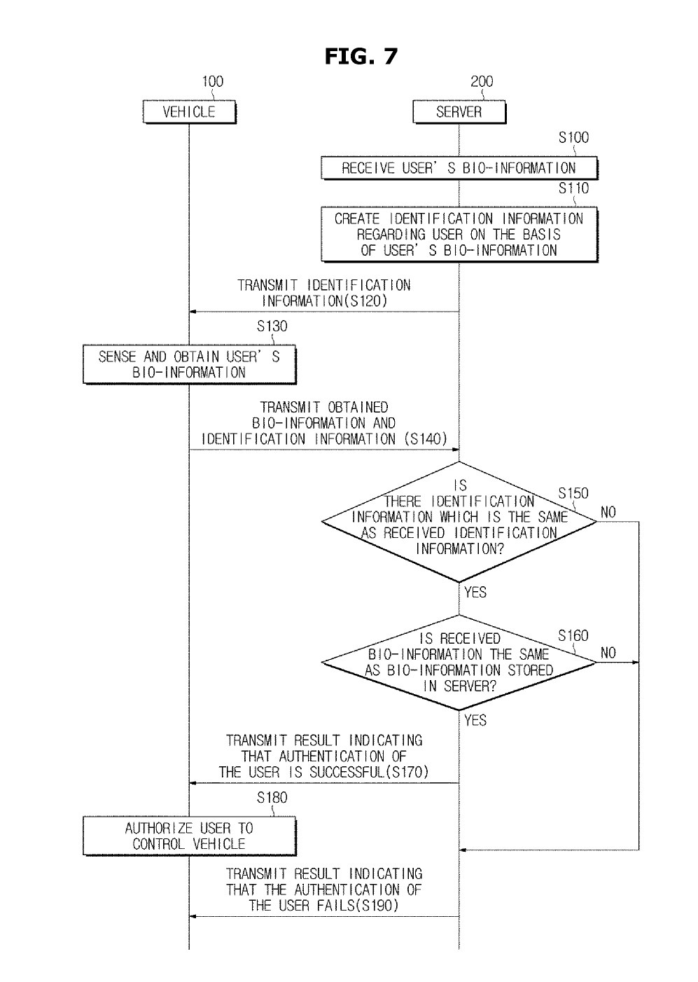

FIG. 7 is a flowchart of a user authentication method in accordance with embodiments of the present disclosure.

As shown in FIG. 7, a server 200 may receive a user's bio-information from the user (S100).

The user should go through an authentication process to use a vehicle sharing system, and thus should register his/her bio-information in the server 200 beforehand. Thus, the server 200 may receive the user's bio-information, e.g., fingerprint information, and store the fingerprint information in the server 200.

The registering of the user's bio-information in the server 200 may be performed remotely by the vehicle 100 or may be performed using a device such as a mobile terminal.

Next, the server 200 creates identification information regarding the user on the basis of the user's bio-information received from the user (S110). In detail, the server 200 may create identification information regarding the user in the form of an ID identifying the user or in the form of a random number.

Next, the server 200 may transmit the user's identification information to the vehicle 100 which the user wants to use (S120).

That is, when the user wants to use a specific vehicle, e.g., the vehicle 100, using a vehicle sharing service, the server 200 may transmit the user's identification information to the vehicle 100 selected by the user.

Next, when the vehicle 100 obtains the user's bio-information, e.g., the user's fingerprint information (S130), the vehicle 100 may transmit both the obtained bio-information and the received identification information to the server 200 (S140).

Thereafter, the server 200 may perform a process of authenticating the user on the basis of the user's identification information and bio-information received from the vehicle 100.

In detail, first, whether identification information which is the same as the user's identification information received from the vehicle 100 is stored in the server 200 may be determined (S150). When identification information which is the same as the received user's identification information is stored in the server 200, whether bio-information which is the same as the user's bio-information received from the vehicle 100 is stored in the server 200 may be determined (S160).

That is, first, whether identification information which is the same as the user's identification information received from the vehicle 100 is stored in the server 200 may be determined. When identification information which is the same as the received user's identification information is stored in the server 200, the user may be authenticated by determining whether bio-information stored in the server 200 corresponding to the same identification information is the same as the user's bio-information received from the vehicle 100.

If both the identification information and the bio-information are the same, the user is authorized to control the vehicle 100. Thus, the user may be successfully authenticated. Thus, in this case, the server 200 may transmit a result indicating that the authentication of the user is successful to the vehicle 100 (S170).

However, when there is not the same identification information or when there is not the same bio-information although there is the same identification information, it means that a user registered in the server 200 and the user who actually wants to use the vehicle 100 are not the same and thus the user is not authenticated. In this case, the server 200 may transmit a result indicating that the authentication of the user has failed to the vehicle 100 (S190).

Although not shown, when the result indicating that the authentication of the user is successful is transmitted (S170), the server 200 may transmit various types of information regarding the user, which are stored therein.

In detail, since the identification information 133 of FIG. 5 may include various types of information, the server 200 may transmit at least one among the user's integrated memory system (IMS) information, head up display (HUD) information and body control module (BCM) information to the vehicle 100. The vehicle 100 receiving this information may authorize the user to control the vehicle 100 and automatically control various components of the vehicle 100 on the basis of the received information (S180).

Although not shown, when use of the vehicle 100 is ended after the user uses the vehicle 100 according to the permission to control the vehicle 100 and the received information, the vehicle 100 may delete the user's identification information and bio-information.

If a vehicle is shared by multiple people, when information regarding a user who first used the vehicle remains in the vehicle, this information is likely to be leaked by another person.

Thus, when it is determined that a user who went through user authentication has ended operation of the vehicle 100, the user's identification information and bio-information may be automatically deleted from the vehicle 100. For example, when an engine of the vehicle 100 is ‘off’, it may be determined that the user's operation of the vehicle 100 has ended. Furthermore, although not shown, when it is determined that the user's operation of the vehicle 100 has ended, the server 200 may delete the user's identification information stored therein.

In cases where a vehicle is shared by multiple drivers, if information regarding a driver is stored in the vehicle 100, this information is likely to be leaked when another driver uses the vehicle 100. Thus, the driver's bio-information is stored in the server 200 rather than the vehicle 100. However, since the driver's identification information should be stored beforehand, the server 200 may recreate identification information and transmit it to the vehicle 100 whenever the driver requests the identification information again.

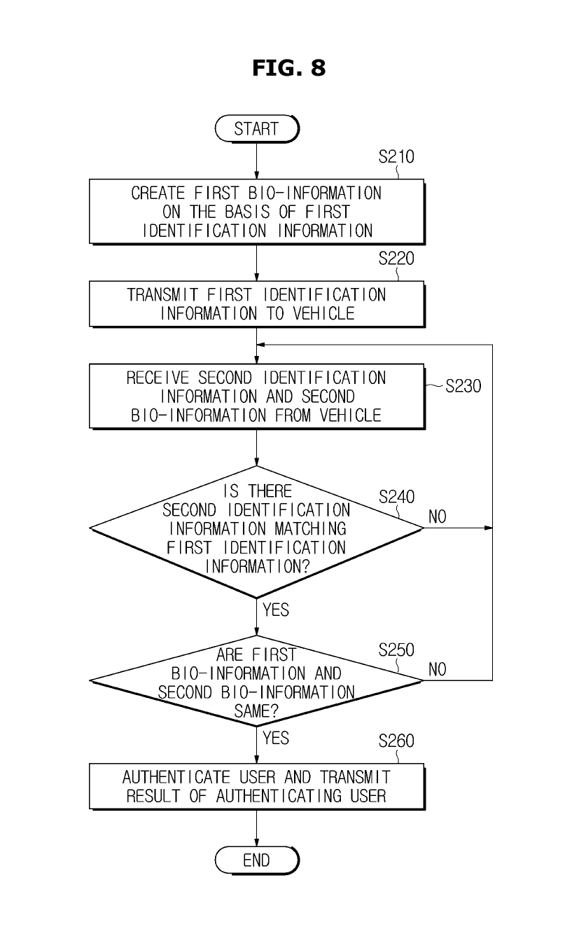

FIG. 8 is a flowchart of a method of controlling the server 200, in accordance with embodiments of the present disclosure.

As shown in FIG. 8, the server 200 may create first bio-information on the basis of first identification information obtained from a user (S210).

In detail, the first identification information may be understood to mean identification information first registered in the server 200 by the user, and the first bio-information may be understood to mean bio-information regarding the user which is created on the basis of the first identification information.

When the first bio-information is created, the server 200 may transmit the first identification information to the vehicle 100 (S220).

Next, second identification information and second bio-information regarding the user may be received from the vehicle 100 (S230).

In detail, the second identification information refers to identification information input by the user. When the first identification information obtained from the user is the same as the second identification information received from the server 200 by the vehicle 100, the vehicle 100 may obtain the second bio-information from the user and transmit the obtained bio-information to the server 200.

When receiving the second identification information from the vehicle 100, the server 200 may determine whether the first identification information matching the second identification information is stored therein (S240).

S230 is an operation of determining whether the first identification information and the second identification information are the same before the user's first bio-information and second bio-information are compared with each other to more quickly perform a user authentication process.

When it is determined in operation S230 that there is the first identification information matching the second identification information, the server 200 may determine whether the first bio-information and the second bio-information are the same (S250).

S240 is an operation of determining whether the user is authorized to use the vehicle 100, in which the user is authenticated by determining whether the user's bio-information obtained from the vehicle 100 and the bio-information stored in the server 200 are the same.

When it is determined in S240 that the first bio-information and the second bio-information are the same, it may be determined that the user is authorized to control the vehicle 100 and thus the server 200 may transmit a result of authenticating the user to the vehicle 100 (S260).

In accordance with embodiments of the present disclosure, the server 200 first determines identity of the user by determining whether pieces of identification information are the same, and determines whether pieces of bio-information are the same when the pieces of identification information are the same as illustrated in FIG. 8, thereby more quickly authenticating the user.

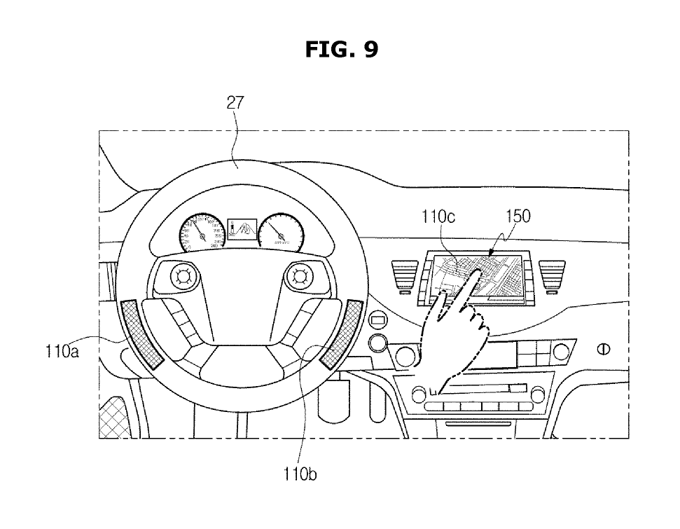

FIGS. 9 to 11 are diagrams illustrating various locations of the sensor 110 capable of obtaining a user's bio-information in accordance with embodiments of the present disclosure.

As shown in FIG. 9, sensors 110a, 110b, and 110c may be provided on a steering wheel 27 or a display 150 of the vehicle 100. Since a user may be likely to manipulate the steering wheel 27 or the display 150 after entering the vehicle 100, the user may perform a user authentication process using the sensors 110a, 110b, and 110c provided on the steering wheel 27 or the display 150.

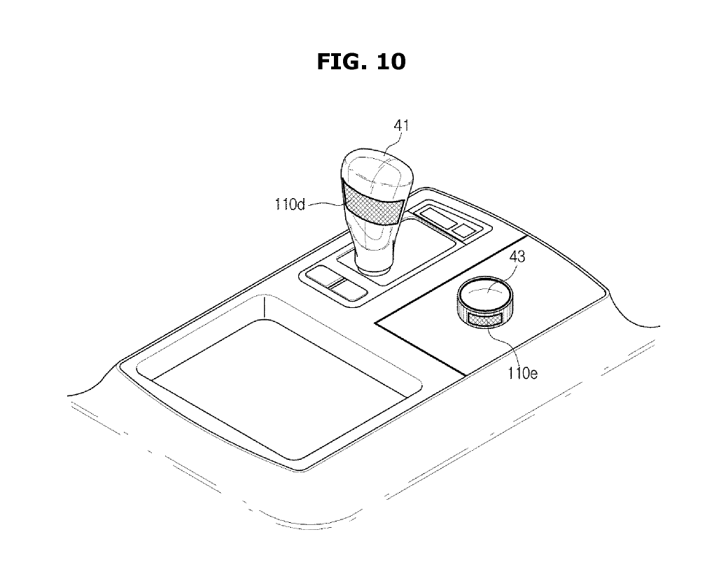

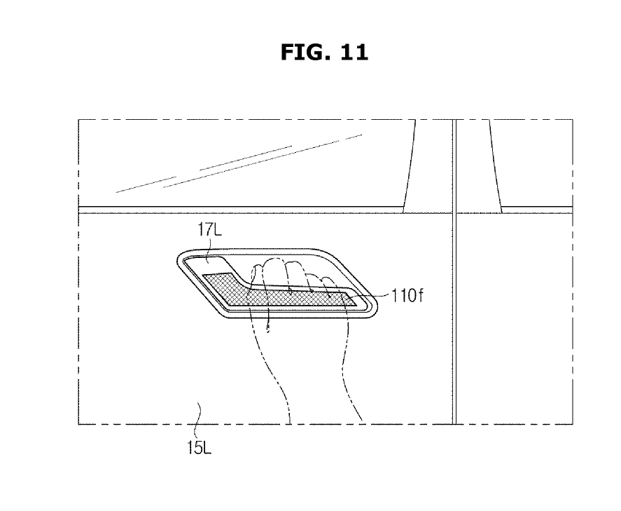

Alternatively, a sensor 110d, 110e, or 110f may be provided on a gearshift 41, a jog shuttle 43 or a handle 17L of the vehicle 100 as illustrated in FIGS. 10 and 11.

In particular, as illustrated in FIG. 11, generally, a user who is located outside the vehicle 100 and wants to use the vehicle 100 may touch the handle 17L of the vehicle 100. Accordingly, the sensor 110f capable of obtaining a user's bio-information may be provided on the handle 17L of the vehicle 100 and thus the user's bio-information may be more easily sensed and obtained.

Although FIGS. 9 to 11 illustrate various locations of the sensor 110, embodiments are not limited thereto and the sensor 110 may be provided on any location of the vehicle 100 at which a user's touch may be sensed.

The structure of the user authentication system 10 and the user authentication method in accordance with embodiments of the present disclosure have been described above with reference to the accompanying drawings.

Conventionally, a user authentication process is performed by comparing bio-information received from a vehicle with each of pieces of bio-information stored in a server. Thus, when a large amount of information regarding a user is stored in the server, much time is needed for the user authentication process.

In contrast, in a user authentication system and a user authentication method in accordance with embodiments of the present disclosure, a user is authenticated by determining the identity of the user using pieces of user's identification information, and comparing pieces of bio-information when the pieces of the user identification information are the same. Therefore, a process of authenticating the user may be more quickly completed than in similar conventional processes.

As is apparent from the above description, a user authentication system in accordance with embodiments of the present disclosure can authenticate a user by determining the identity of a user using pieces of identification information of the user, and then comparing pieces of bio-information when the pieces of identification information are the same. Accordingly, a user authentication process can be more quickly completed than with conventional approaches.

While the present disclosure has been described above with reference to certain embodiments and the drawings, various changes and modifications may be made on the basis of the above description by those of ordinary skill in the art. For example, an appropriate result may be obtained even when the above-described techniques may be performed in an order different from that described herein and/or when the above-described components such as a system, structure, device, circuit, etc. are coupled to or combined with each other in a form different from that described herein or are replaced or substituted with other components or equivalents thereto. Accordingly, it should be understood that other embodiments and equivalents of the claims fall within the scope of the following claims.

What is claimed is:

1. A user authentication system comprising:
a server storing identification information and bio-information of a user; and a vehicle comprising:
a receiver receiving the identification information from the server;
a sensor sensing bio-information; and
a transmitter transmitting the sensed bio-information and the received identification information to the server,
wherein the server authenticates the user based on the identification information and the bio-information received from the transmitter.

2. The user authentication system according to claim 1, wherein, when the identification information received from the transmitter is the same as the identification information stored in the server, the server authenticates the user based on the bio-information received from the transmitter.

3. The user authentication system according to claim 1, wherein the server authenticates the user based on whether the identification information received from the transmitter is the same as the identification information stored in the server.

4. The user authentication system according to claim 1, wherein the vehicle further comprises a controller controlling an operation of the vehicle based on the information received by the receiver.

5. The user authentication system according to claim 1, wherein the server creates identification information of the user based on the bio-information of the user.

6. The user authentication system according to claim 4, wherein, when the authenticated user's operation of the vehicle has ended, the controller deletes the identification information and the bio-information of the user.

7. The user authentication system according to claim 6, wherein, when the authenticated user's operation of the vehicle has ended, the server deletes the identification information of the user and creates new identification information of the user.

8. The user authentication system according to claim 7, wherein the server transmits the new identification information of the user to the receiver.

9. A user authentication method of a user authentication system including a vehicle and a server, the method comprising:
receiving bio-information from a user;
creating identification information of the user based on the bio-information;
storing the created identification information and the bio-information in the server;
transmitting the identification information to the vehicle;
sensing bio-information of the user;
transmitting the sensed bio-information and the identification information to the server; and
authenticating the user based on the identification information and the bio-information received from the vehicle.

10. The user authentication method according to claim 9, wherein the authenticating of the user comprises authenticating the user based on the bio-information received from the vehicle when the identification information received from the vehicle is the same as the identification information stored in the server.

11. The user authentication method according to claim 10, wherein the authenticating of the user comprises authenticating the user based on whether the identification information received from the vehicle is the same as the identification information stored in the server.

12. The user authentication method according to claim 9, wherein the creating of the identification information of the user comprises creating identification information of the user based on the bio-information of the user.

13. The user authentication method according to claim 9, further comprising deleting the identification information and the bio-information of an authenticated user when an operation of the vehicle by the authenticated user has ended.

14. A server comprising:
a server storage part storing first identification information and first bio-information of a user;
a server communicator transmitting the first identification information of the user to a vehicle and receiving second identification information and second bio-information of the user from the vehicle; and
a server controller authenticating the user based on the first bio-information and the second bio-information of the user when the first identification information is the same as the second identification information.

15. The server according to claim 14, wherein, when the first identification information is the same as the second identification information, the server controller determines that the user is authorized to control the vehicle, and authenticates the user.

16. The server according to claim 14, wherein the first bio-information is created based on the first identification information.

17. The server according to claim 15, wherein the second bio-information including bio-information of the user obtained from the vehicle.

18. The server according to claim 14, wherein the server communicator transmits a result of the authentication of the user to the vehicle.

19. The server according to claim 14, wherein, when an operation of the vehicle by an authenticated user has ended, the server controller deletes the first identification information and the second identification information and creates new first identification information of the user.

20. The server according to claim 19, wherein the server communicator transmits the new first identification information of the user to the vehicle.
